(19) United States
(12) Patent Application Publication
(10) Pub. No.: US 2017/0064619 A1
(43) Pub. Date: Mar. 2, 2017

(54) SELECTIVE WLAN SCANNING OPERATIONS DURING SCO CALLS

(71) Applicant: QUALCOMM Incorporated, San Diego, CA (US)

(72) Inventors: Kiran Neelisetty, Hyderabad (IN); Ashwani Dwivedi, Hyderabad (IN); Sudhanshu Singh, Hyderabad (IN); Ramesh Naik, Hyderabad (IN)

(21) Appl. No.: 14/843,804

(22) Filed: Sep. 2, 2015

(51) Int. Cl. H04W 48/16; H04W 72/04; H04W 4/00; H04L 12/26

(52) U.S. Cl. CPC H04W 48/16; H04L 43/12; H04W 72/0446; H04W 4/008; H04W 84/12

(57) ABSTRACT

In a wireless network, a method for operating a wireless device including at least a wireless local area network (WLAN) transceiver and a Bluetooth (BT) transceiver, the method comprising facilitating a voice-over-IP (VoIP) call with another device using the WLAN transceiver and the BT transceiver; initiating a WLAN scanning operation by transmitting a probe request, over a wireless channel, to one or more access points (APs); instructing the one or more APs to delay sending a probe response for a delay period; and selectively terminating the WLAN scanning operation based at least in part on a determination that the wireless channel has been idle for more than a wait period after expiration of the delay period.

### TECHNICAL FIELD

The example embodiments relate generally to wireless networks, and specifically to reducing interference during scanning operations.

### BACKGROUND OF RELATED ART

Many wireless devices such as smartphones and tablet computers are capable of wireless communication with other devices using multiple technologies including, for example, Wi-Fi signals, BLUETOOTH® (BT or Bluetooth) signals, near field communication (NFC) signals, and cellular signals such as long term evolution (LTE) signals. Because BT signals and some Wi-Fi signals may be transmitted at similar frequencies (e.g., in the ISM band, between approximately 2.4 and 2.5 GHz), it is desirable for wireless devices to reduce an amount of interference between BT signals and Wi-Fi signals. For example, when a wireless device is facilitating a voice-over-Internet Protocol (VoIP) call using Wi-Fi signals and routing audio signals associated with the VoIP call to a wireless headset using BT signals (e.g., in a Synchronous Connection Oriented (SCO) call), transmission of Wi-Fi signals may interfere with reception of BT signals, which in turn may degrade the Mean Opinion Score (MOS) of the SCO call.

When the wireless device is moved within a wireless local area network (WLAN) and/or between WLANs, the wireless device may periodically scan for nearby access points (APs), for example, to identify the best available AP with which to associate. Performing WLAN scanning operations while facilitating an SCO call may further degrade the MOS of the SCO call. Some wireless devices may not perform WLAN scanning operations during SCO calls to minimize interference between Wi-Fi signals and BT signals. However, avoiding WLAN scanning operations during SCO calls may prevent the wireless device from identifying the best available AP with which to associate, which in turn may also degrade the quality of the call when the STA is roaming between APs and/or between wireless networks.

Thus, there is a need to minimize interference between Wi-Fi signals and BT signals during an SCO call without preventing the wireless device from performing WLAN scanning to identify the best available AP with which to associate.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

Methods and apparatuses are disclosed that may allow a wireless device to reduce interference of Bluetooth signals caused by WLAN scanning operations. As mentioned above, when a wireless device such as a STA is facilitating a VoIP call using Wi-Fi signals and routing audio signals associated with the VoIP call to a wireless headset using BT signals, transmission of the Wi-Fi signals may interfere with reception of the BT signals, which is undesirable. Thus, in accordance with the example embodiments, a wireless device such as a STA may be configured to complete WLAN scanning operations during an SCO call only when there is a likelihood of identifying a better AP with which to associate. In this manner, the frequency of WLAN scanning operations during SCO calls may be reduced (e.g., as compared with wireless devices that always perform WLAN scanning operations during SCO calls) without sacrificing the ability to identify the best available AP with which to associate (e.g., as compared with wireless devices do not perform WLAN scanning operations during SCO calls).

For at least one embodiment, the wireless device may facilitate a voice call using a wireless local area network (WLAN) transceiver and a Bluetooth (BT) transceiver; may initiate a WLAN scanning operation during the voice call by broadcasting a probe request, over a wireless channel, to one or more access points (APs); may instruct the one or more APs to delay sending a probe response for a delay period; and may selectively terminate the WLAN scanning operation based at least in part on a determination that the wireless channel has been idle for more than a wait period after expiration of the delay period. The wireless device may terminate the WLAN scanning operation based on a determination that the wireless device has not received any probe responses during the wait period, and may complete the WLAN scanning operation based on a determination that the wireless device has received one or more probe responses during the wait period.

For some implementations, the wireless device may broadcast the probe request to the one or more APs at a beginning of a time slot allocated to the WLAN transceiver. The wireless device may instruct the one or more APs to delay sending a probe response by transmitting, to the one or more APs, a CTS-to-Self frame specifying the delay period. The CTS-to-Self frame may be transmitted during the time slot allocated to the WLAN transceiver.

### BRIEF DESCRIPTION OF THE DRAWINGS

The example embodiments are illustrated by way of example and are not intended to be limited by the figures of the accompanying drawings, where like reference numerals refer to corresponding parts throughout the drawing figures.

FIG. 1 shows a block diagram of a wireless system within which the example embodiments may be implemented.

FIG. 2 shows a block diagram of a wireless station (STA) in accordance with example embodiments.

FIG. 3A is a timing diagram depicting an example allocation of WLAN time slots and Bluetooth time slots for a shared antenna of the STA of FIG. 2.

FIG. 3B is a sequence and timing diagram depicting an example scanning operation in accordance with some embodiments.

FIG. 3C is a sequence and timing diagram depicting another example scanning operation in accordance with some embodiments.

FIG. 4 shows an example CTS-to-Self frame in accordance with example embodiments.

FIG. 5 is an illustrative flow chart depicting an example operation for selectively terminating WLAN scanning operations during a VoIP/SCO call in accordance with example embodiments.

FIG. 6 is a block diagram of another wireless station (STA) in accordance with example embodiments.

### DETAILED DESCRIPTION

The example embodiments are described below in the context of a mobile station (STA) operating in a WLAN system for simplicity only. It is to be understood that the example embodiments are equally applicable to other types of devices and/or to other wireless networks (e.g., cellular networks, pico networks, femto networks, satellite networks). As used herein, the terms “wireless local area network (WLAN)” and “Wi-Fi” can include communications governed by the IEEE 802.11 family of standards, and the term “Bluetooth” can include communications governed by the IEEE 802.15 family of standards and/or governed by HiperLAN (a set of wireless standards, comparable to the IEEE 802.11 standards, used primarily in Europe). Further, although described below in terms of an infrastructure WLAN system including one or more APs, the example embodiments are equally applicable to other WLAN systems including, for example, multiple WLANs, Independent Basic Service Set (IBSS) networks, ad-hoc networks, peer-to-peer (P2P) networks (e.g., operating according to the Wi-Fi Direct protocols), and/or Hotspots.

In addition, although described herein in terms of exchanging data frames between wireless devices, the example embodiments may be applied to the exchange of any data unit, packet, and/or frame between wireless devices. Thus, the term “frame” may include any frame, packet, or data unit such as, for example, protocol data units (PDUs), media access control (MAC) protocol data units (MPDUs), and physical layer convergence procedure protocol data units (PPDUs). The term “A-MPDU” may refer to aggregated MPDUs.

As used herein, the term “associated AP” refers to an AP with which a given STA is associated (e.g., there is an established communication channel or link between the AP and the given STA). The term “non-associated AP” refers to an AP with which a given STA is not associated (e.g., there is not an established communication channel or link between the AP and the given STA, and thus the AP and the given STA may not yet exchange data frames). The term “associated STA” refers to a STA that is associated with a given AP, and the term “non-associated STA” refers to a STA that is not associated with the given AP.

Further, the term “goodput” may refer to an effective data rate of a wireless channel or link between two wireless devices (e.g., between a STA and an AP). When a wireless device such as a STA is moved into the coverage area of a wireless network, it may be desirable for the STA to select the best available AP with which to associate. As used herein, the term “best available AP” may refer to the AP that provides the highest goodput (e.g., as compared with the goodput of other nearby candidate APs). In addition, after the STA becomes associated with a particular AP, it may be desirable for the STA to continually (e.g., periodically) scan the surrounding environment to determine whether one or more other (e.g., non-associated) APs may offer the STA better goodput than the AP with which the STA is currently associated.

In the following description, numerous specific details are set forth such as examples of specific components, circuits, and processes to provide a thorough understanding of the present disclosure. The term “coupled” as used herein means coupled directly to or coupled through one or more intervening components or circuits. Also, in the following description and for purposes of explanation, specific nomenclature is set forth to provide a thorough understanding of the present embodiments. However, it will be apparent to one skilled in the art that these specific details may not be required to practice the present embodiments. In other instances, well-known circuits and devices are shown in block diagram form to avoid obscuring the present disclosure. Any of the signals provided over various buses described herein may be time-multiplexed with other signals and provided over one or more common buses. Additionally, the interconnection between circuit elements or software blocks may be shown as buses or as single signal lines. Each of the buses may alternatively be a single signal line, and each of the single signal lines may alternatively be buses, and a single line or bus might represent any one or more of a myriad of physical or logical mechanisms for communication between components.

Some portions of this disclosure which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In this disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout this disclosure, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments described herein may be discussed in the general context of processor-executable instructions residing on some form of processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, performs one or more of the methods described above. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that may be accessed, read, and/or executed by a computer or other processor.

The various illustrative logical blocks, modules, circuits and instructions described in connection with the embodiments disclosed herein may be executed by one or more processors, such as one or more digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structure or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other suitable configuration.

A wireless local area network (WLAN) may be formed by one or more access points (APs) that provide a shared wireless communication medium for use by a number of client devices such as mobile stations (STAs). Each AP, which may correspond to a Basic Service Set (BSS), periodically broadcasts beacon frames to enable any STAs within wireless range of the AP to establish and/or maintain a communication link with the AP. In a typical WLAN, only one STA may use the wireless medium at any given time, and each STA may be associated with only one AP at a time. Due to the increasing ubiquity of wireless networks, when a STA seeks to join a wireless network, the STA may have a choice between multiple wireless networks and/or between multiple APs that form an extended BSS. As the STA is moved into the coverage area of one or more wireless networks, the STA may select the best AP with which to associate. After the STA becomes associated with the selected AP, the STA may be moved within and/or between the coverage area of the one or more wireless networks, and may subsequently benefit from switching its association from the currently associated AP to one of a number of candidate APs (e.g., APs with which the STA is not associated), for example, to achieve the highest possible data rate.

As mentioned above, when a wireless device such as a STA is facilitating a VoIP call using Wi-Fi signals and routing audio signals associated with the VoIP call to a wireless headset using BT signals, transmission of the Wi-Fi signals may interfere with reception of the BT signals, which is undesirable. Although this interference may be reduced by preventing the STA from scanning for nearby APs during the voice call, WLAN scanning operations are desirable to identify the best available AP with which to associate, especially when the STA is moving within a given WLAN and/or between WLANs. Thus, in accordance with the example embodiments, a wireless device such as a STA may be configured to complete WLAN scanning operations during an SCO call only when there is a likelihood of identifying a better AP with which to associate. In this manner, the frequency of WLAN scanning operations during SCO calls may be reduced (e.g., as compared with wireless devices that always perform WLAN scanning operations during SCO calls) without sacrificing the ability to identify the best available AP with which to associate (e.g., as compared with wireless devices do not perform WLAN scanning operations during SCO calls). These are at least some of the technical solutions provided by the example embodiments to the aforementioned technical problems, as discussed in detail below.

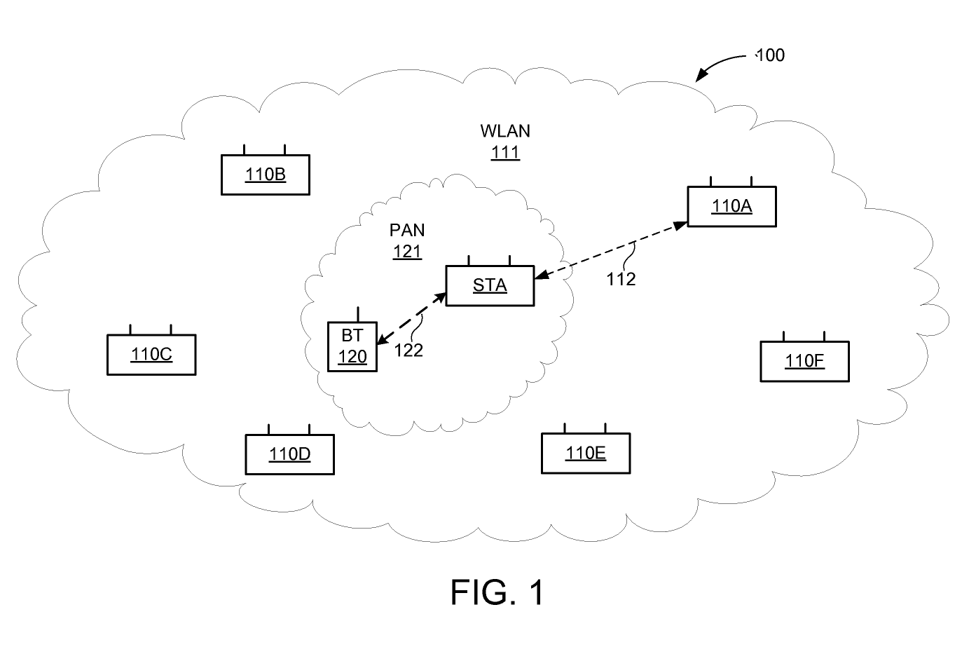

FIG. 1 is a block diagram of a wireless system 100 within which the example embodiments may be implemented. The wireless system 100 is shown to include a wireless station (STA), a plurality of wireless access points (APs) 110A-110F, a wireless local area network (WLAN) 111, a Bluetooth headset 120, and a personal area network (PAN) 121. The WLAN 111 may be formed by any number of APs such as APs 110A-110F that may operate according to the IEEE 802.11 family of standards (or according to other suitable wireless protocols). Thus, although six APs 110A-110F are shown in the example of FIG. 1, it is to be understood that WLAN 111 may be formed by any number of access points. Each of the APs 110A-110F is assigned a unique MAC address that is programmed therein by, for example, the manufacturer of the access point. Similarly, the STA is also assigned a unique MAC address. Once the STA is authenticated to and associated with an AP, the STA and the AP may exchange data with each other over a shared wireless channel or link.

More specifically, establishing a Wi-Fi connection between an AP and a STA typically involves a number of steps to be completed before the STA and the AP may begin exchanging data with each another. First, the STA typically scans all available channels (e.g., by broadcasting probe requests and/or by listening for beacon frames) to identify APs and/or other devices that are within wireless range of the STA. Each available AP may respond to the probe requests by transmitting, to the STA, a probe response containing basic service set (BSS) information pertaining to that AP's network. Next, the STA selects one of the APs with which to associate. For example, the STA may select the AP having the highest signal strength or having the highest goodput. Then, the STA may authenticate and associate with the selected AP.

For the example depicted in FIG. 1, the STA is associated with AP 110A, and may exchange signals or frames with AP 110A via a Wi-Fi link 112. The other APs 110B-110F are not associated with the STA, and are therefore deemed to be non-associated APs. Although the STA is currently associated with AP 110A, the STA may be moved within the WLAN 111 and/or into the coverage area of one or more other wireless networks (not shown for simplicity), and therefore may subsequently benefit from switching its association from AP 110A to another one of APs 110B-110F in WLAN 111 or to an AP corresponding to another wireless network.

The PAN 121, which may also be referred to as a Bluetooth network, may be created by pairing the STA and the BT headset 120 so that data may be exchanged between the STA and BT headset 120 via a Bluetooth link 122. For example, when the STA is facilitating a voice call, the STA may route audio signals as a Synchronous Connection Oriented (SCO) call via the Bluetooth link 122 to BT headset 120. The STA may facilitate the voice call using cellular signals or using Wi-Fi signals. For the example embodiments described herein, the voice call facilitated by the STA may be a VoIP call for which data frames containing audio signals related to the voice call are exchanged with an associated one of the APs 110A-110F over a shared wireless channel or communication link using Wi-Fi signals.

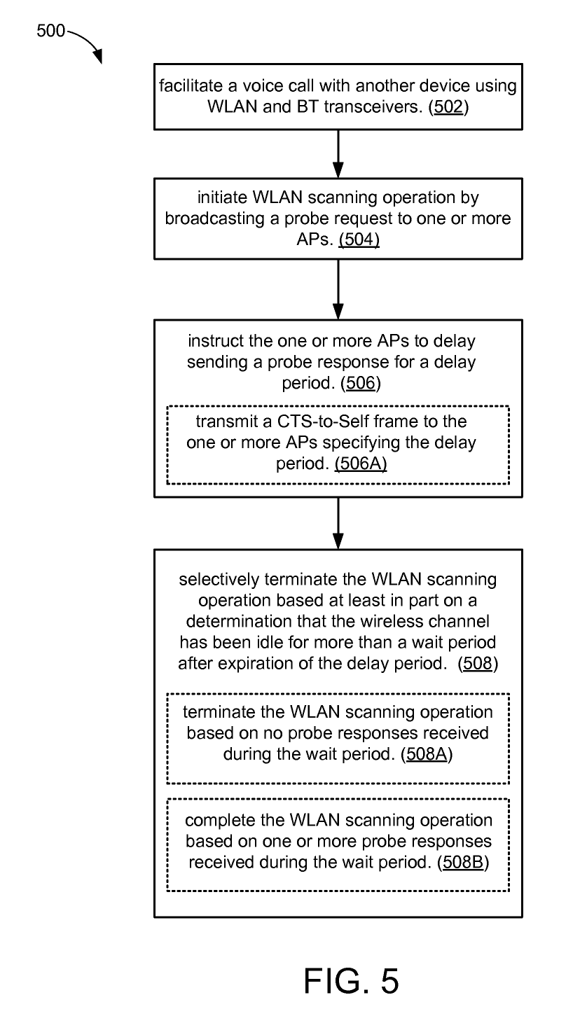

The STA may be any suitable Wi-Fi enabled wireless device including, for example, a cell phone, personal digital assistant (PDA), tablet device, laptop computer, or the like. The STA may also be referred to as a user equipment (UE), a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. For at least some embodiments, the STA may include one or more transceivers, one or more processing resources (e.g., processors and/or ASICs), one or more memory resources, and a power source (e.g., a battery). The memory resources may include a non-transitory computer-readable medium (e.g., one or more nonvolatile memory elements, such as EPROM, EEPROM, Flash memory, a hard drive, etc.) that stores instructions for performing operations described below with respect to FIG. 5.

The APs 110A-110F may be any suitable device that allows one or more wireless devices to connect to a network (e.g., a local area network (LAN), wide area network (WAN), metropolitan area network (MAN), and/or the Internet) via any of the APs 110A-110F using Wi-Fi, Bluetooth, or any other suitable wireless communication standards. For at least one embodiment, each of APs 110A-110F may include one or more transceivers, one or more processing resources (e.g., processors and/or ASICs), one or more memory resources, and a power source. The memory resources may include a non-transitory computer-readable medium (e.g., one or more nonvolatile memory elements, such as EPROM, EEPROM, Flash memory, a hard drive, etc.) that stores instructions for performing operations described below with respect to FIG. 5.

For the STA and/or APs 110A-110F, the one or more transceivers may include Wi-Fi transceivers, Bluetooth transceivers, cellular transceivers, and/or other suitable radio frequency (RF) transceivers (not shown for simplicity) to transmit and receive wireless communication signals. Each transceiver may communicate with other wireless devices in distinct operating frequency bands and/or using distinct communication protocols. For example, the Wi-Fi transceiver may communicate within a 2.4 GHz frequency band, within a 5 GHz frequency band, and/or within a 60 GHz frequency band. The cellular transceiver may communicate within various RF frequency bands in accordance with a 4G Long Term Evolution (LTE) protocol described by the 3rd Generation Partnership Project (3GPP) (e.g., between approximately 700 MHz and approximately 3.9 GHz) and/or in accordance with other cellular protocols (e.g., a Global System for Mobile (GSM) communications protocol). In other embodiments, the transceivers included within the STA and/or the APs 110A-110F may be any technically feasible transceiver such as a ZigBee transceiver described by a specification from the ZigBee specification, a WiGig transceiver, and/or a HomePlug transceiver described a specification from the HomePlug Alliance.

As mentioned above, for wireless devices (e.g., STAs) that include collocated Bluetooth (BT) and WLAN transceivers, it is desirable to reduce interference between BT signals and Wi-Fi signals, particularly when both the BT signals and the Wi-Fi signals are transmitted at similar frequencies (e.g., in the ISM band, between approximately 2.4 and 2.5 GHz). More specifically, even though BT signals may utilize adaptive frequency hopping (AFH) techniques to avoid specific frequencies used by Wi-Fi transmissions, AFH techniques may not adequately mitigate interference, especially when the WLAN transceivers and the BT transceivers are integrated into the same device (e.g., as in the STA of FIG. 1). Thus, when a wireless device such as the STA of FIG. 1 is facilitating an SCO call via BT headset 120, the concurrent transmission and/or reception of Wi-Fi signals may interfere with the exchange of BT signals between the STA and BT headset 120, thereby degrading the audio quality (e.g., the MOS) of the SCO call.

The interference between Wi-Fi signals and BT signals may be especially high when the STA is facilitating a VoIP call and routing audio signals associated with the VoIP call to BT headset 120. Further, as the STA moves within the WLAN 111, it is desirable for the STA to perform WLAN scanning operations to ensure that the STA is associated with the best available AP, for example, so that the VoIP call is not dropped. However, as mentioned above, WLAN scanning operations may further increase interference between Wi-Fi signals and BT signals, which in turn may further degrade the quality of the VoIP call. In addition, for implementations in which the STA's BT transceivers and WLAN transceivers share the same antenna, performing WLAN scanning operations during an SCO call may undesirably reduce an amount of antenna resources allocated to exchanging BT signals between the STA and the BT headset 120.

Accordingly, as mentioned above, the example embodiments disclosed herein may reduce an amount of interference between Wi-Fi signals and BT signals during an SCO call by completing WLAN scanning operations only when there is a likelihood of identifying a better AP with which to associate. More specifically, after broadcasting probe requests to a number of APs (e.g., to initiate a WLAN scanning operation), the STA may instruct the APs to delay sending probe responses for a delay period, and then selectively terminate the WLAN scanning operation based, at least in part, on whether any probe responses are received from the APs during a wait period after expiration of the delay period. For at least some embodiments, the STA may terminate the WLAN scanning operation when no probe responses are received during the wait period, and may complete the WLAN scanning operation when one or more probe responses are received during the wait period. These and other details of the example embodiments are described in more detail below.

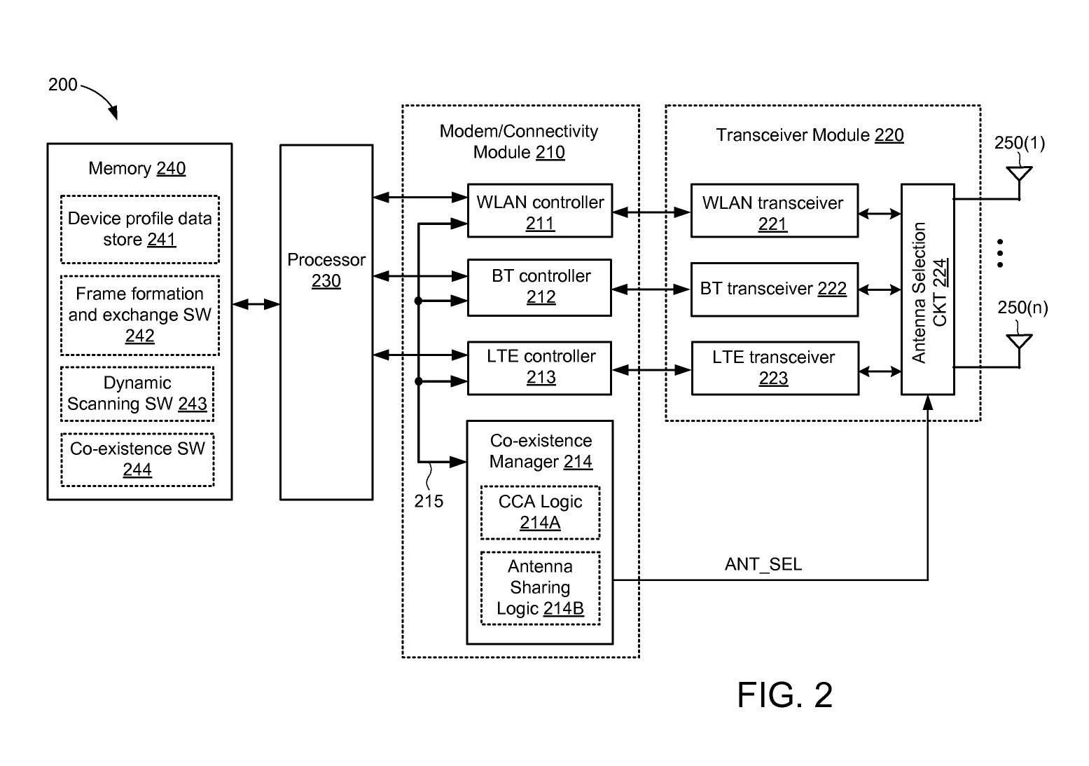

FIG. 2 is a block diagram of a STA 200 that may be one embodiment of the STA of FIG. 1. STA 200 is shown to include a modem/connectivity module 210, a bus 215, a transceiver module 220, a processor 230, a memory 240, and a number of antennas 250(1)-250(n). The modem/connectivity module 210 includes a WLAN controller 211, a Bluetooth controller 212, an LTE controller 213, and a co-existence manager 214. The WLAN controller 211 is configured to control the transmission and reception of Wi-Fi signals for STA 200. The Bluetooth controller 212 is configured to control the transmission and reception of Bluetooth signals for STA 200. The LTE controller 213 is configured to control the transmission and reception of LTE signals (or other suitable cellular signals) for STA 200.

The WLAN controller 211, Bluetooth controller 212, and LTE controller 213 may be coupled to processor 230 via separate signal lines, and may be coupled to each other and to co-existence manager 214 via bus 215. For some embodiments, the bus 215 is a Wireless Co-existence Interface (WCI) bus that may operate according to one or more Bluetooth standards. For such embodiments, the WCI bus 215 may be used to exchange synchronization messages and status information between WLAN controller 211, Bluetooth controller 212, LTE controller 213, and/or co-existence manager 214. For at least some embodiments, the WLAN controller 211 and Bluetooth controller 212 may correspond to a wireless connectivity module.

The co-existence manager 214 may include Clear Channel Assessment (CCA) logic 214A and antenna sharing logic 214B. CCA logic 214A may be used by co-existence manager 214 to determine whether the Wi-Fi wireless channel has been idle for a certain amount of time (e.g., corresponding to the delay period and/or the wait period, as discussed in more detail below). CCA logic 214A may use Clear Channel Assessment CCA techniques to sense or determine whether the wireless channel is idle or busy. Additionally, for at least some embodiments, CCA logic 214A may selectively terminate WLAN scanning operations, for example, when no probe responses are received by the STA during the wait period.

Antenna sharing logic 214B may selectively route signals associated with the WLAN controller 211, the Bluetooth controller 212, and/or the LTE controller 213 to one or more of the antennas 250(1)-250(n) for transmission from the STA 200. For example, when the WLAN controller 211 is not transmitting or receiving data, the antenna sharing logic 214B may provision more antenna resources to the Bluetooth controller 212; conversely, when the Bluetooth controller 212 is not transmitting or receiving data, the antenna sharing logic 214B may provision more antenna resources to the WLAN controller 211.

Antenna sharing logic 214B may also allocate transmission time slots to the WLAN controller 211 and to the Bluetooth controller 212 when the WLAN controller 211 and the Bluetooth controller 212 are to share one or more of antennas 250(1)-250(n). More specifically, for example embodiments in which the WLAN controller 211 and the Bluetooth controller 212 are to share a single antenna, the antenna sharing logic 214B may implement an antenna sharing policy by dividing each of a number of antenna sharing time periods into a WLAN time slot and a BT time slot. Thereafter, the STA 200 may transmit and receive Wi-Fi signals using the single antenna during the WLAN time slots, and may transmit and receive BT signals using the single antenna during the BT time slots. For at least one example implementation, the transmit time period is approximately 4 milliseconds (ms), the WLAN time slot occupies approximately 2.5 ms of each of the 4 ms transmit time periods, and the BT time slot occupies approximately 1.5 ms of each of the 4 ms transmit time periods.

Although shown in FIG. 2 as separate components, the WLAN controller 211, Bluetooth controller 212, LTE controller 213, and co-existence manager 214 may be implemented on the same integrated circuit (IC) chip. For other embodiments, the WLAN controller 211, Bluetooth controller 212, LTE controller 213, and co-existence manager 214 may share one or more components on the same chip.

Note that the various components (not shown for simplicity) within processor 230, WLAN controller 211, Bluetooth controller 212, LTE controller 213, and/or co-existence manager 214 may be implemented in a variety of ways including, for example, using analog logic, digital logic, processors (e.g., CPUs, DSPs, microcontrollers, and so on), application specific integrated circuits (ASICs), field programmable gate arrays (FPGAs), or any combination of the above. For purposes of this disclosure, modem/connectivity module 210 may include not only digital processing circuitry but also analog (e.g., RF) processing circuitry.

Transceiver module 220, which is coupled between modem/connectivity module 210 and antennas 250(1)-250(n), is shown in the example of FIG. 2 as including a WLAN transceiver 221, a Bluetooth transceiver 222, an LTE transceiver 223, and an antenna selection circuit 224. The WLAN transceiver 221 may route Wi-Fi signals between WLAN controller 211 and the antennas 250(1)-250(n) via antenna selection circuit 224. The Bluetooth transceiver 222 may route Bluetooth signals between Bluetooth controller 212 and the antennas 250(1)-250(n) via antenna selection circuit 224. The LTE transceiver 223 may route LTE signals between LTE controller 213 and the antennas 250(1)-250(n) via antenna selection circuit 224. Although not shown in FIG. 2 for simplicity, each of transceivers 221-223 may include any suitable circuits (e.g., power amplifiers, filters, up-samplers, down-samplers, analog-to-digital converters, digital-to-analog converters, mixers, etc.) to facilitate the transmission and reception of corresponding wireless signals. Further, although not shown in FIG. 2, the WLAN transceiver 221, the Bluetooth transceiver 222, and the LTE transceiver 223 may each include any suitable number of transmit chains and receive chains.

The antenna selection circuit 224, which is coupled between transceivers 221-223 and antennas 250(1)-250(n), may selectively couple each of transceivers 221-223 to any of the antennas 250(1)-250(n) in response to an antenna select signal (ANT SEL). The ANT SEL signal may be generated by the co-existence manager 214. More specifically, for example embodiments described herein, the ANT SEL signal may be generated by antenna sharing logic 214B in accordance with the aforementioned antenna sharing policy. For example, if Wi-Fi and BT communications associated with STA 200 are to share the first antenna 250(1), then the antenna sharing logic 214B may drive the ANT SEL signal to a first state that couples the first antenna 250(1) to the WLAN transceiver 221 during the WLAN time slots, and may drive the ANT SEL signal to a second state that couples the first antenna 250(1) to the BT transceiver 222 during the BT time slots.

The co-existence manager 214 may coordinate the transmission/reception of Wi-Fi signals with the transmission/reception of BT signals, for example, to reduce interference between the Wi-Fi signals and the BT signals. For some embodiments, the co-existence manager 214 may receive Wi-Fi transmit/receive information from the WLAN controller 211, and may receive BT transmit/receive information from the Bluetooth controller 212. For other embodiments, the co-existence manager 214 may receive Wi-Fi transmit/receive information and/or BT transmit/receive information from processor 230.

Memory 240 may include a device profile data store 241 that stores profile information for a plurality of devices such as APs, Bluetooth devices, and/or other STAs. The profile information for a particular device may include information including, for example, the device's service set identifier (SSID), MAC address, channel information, received signal strength indicator (RSSI) values, supported data rates, BT pairing information, and any other suitable information pertaining to or describing the operation of the device.

Memory 240 may also include a non-transitory computer-readable medium (e.g., one or more nonvolatile memory elements, such as EPROM, EEPROM, Flash memory, a hard drive, and so on) that can store the following software (SW) modules:
a frame formation and exchange SW module 342 to create, transmit, and/or receive any suitable data frames, control frames (e.g., probe requests and CTS-to-self frames), and/or action frames to and from other wireless devices, and to embed delay instructions and the delay period into CTS-to-self frames created in accordance with the example embodiments, for example, as described for one or more operations of FIG. 5;
a dynamic scanning SW module 243 to initiate WLAN scanning operations on a particular wireless channel by broadcasting probe requests, to calculate the delay period to be embedded into CTS-to-self frames created by the frame formation and exchange SW module 342, to calculate the wait period, and to selectively terminate WLAN scanning operations based, at least in part, on whether any probe responses are received during the wait period, for example, as described for one or more operations of FIG. 5; and
a co-existence software module 244 to manage the co-existence of WLAN and BT communications associated with STA 200 (e.g., during a VoIP and/or SCO call) and to selectively terminate BT communications during WLAN scanning operations based on determinations made by the dynamic scanning SW module 243, for example, as described for one or more operations of FIG. 5.

Each software module includes instructions that, when executed by processor 230, cause STA 200 to perform the corresponding functions. The non-transitory computer-readable medium of memory 240 thus includes instructions for performing all or a portion of the operations depicted in FIG. 5.

Processor 230 may be any suitable one or more processors capable of executing scripts or instructions of one or more software programs stored in STA 200 (e.g., within memory 240). For example, processor 230 may execute the frame formation and exchange SW module 342 to create, transmit, and/or receive any suitable data frames, control frames (e.g., probe requests and CTS-to-self frames), and/or action frames to and from other wireless devices, and to embed delay instructions and the delay period into CTS-to-self frames created in accordance with the example embodiments. Processor 230 may execute dynamic scanning SW module 243 to initiate WLAN scanning operations on a particular wireless channel by broadcasting probe requests, to calculate the delay period to be embedded into CTS-to-self frames created by the frame formation and exchange SW module 242, to calculate the wait period, and/or to selectively terminate WLAN scanning operations based, at least in part, on whether any probe responses are received during the wait period. Processor 230 may execute the co-existence software module 244 to manage the co-existence of WLAN and BT communications associated with STA 200 (e.g., during a VoIP and/or SCO call) and to selectively terminate BT communications during WLAN scanning operations based on determinations made by the dynamic scanning SW module 243.

Referring also to FIG. 1, when STA 200 commences a VoIP call via its WLAN controller 211 and WLAN transceiver 221, and concurrently uses its Bluetooth controller 212 and Bluetooth transceiver 222 to route audio signals associated with the VoIP call to BT headset 120, STA 200 may be associated with AP 110A. However, as STA 200 changes locations (e.g., due to movement of STA 200 relative to the associated AP 110A) while facilitating the VoIP/SCO call, AP 110A may no longer be the best available AP with which to associate. Accordingly, the STA 200 may initiate a WLAN scanning operation to search for the best available AP by broadcasting a probe request to one or more APs (AP 110A through 110F) in WLAN 111. As mentioned above, WLAN scanning operations may interfere with BT communications and reduce the quality of audio signals transmitted to and from the BT headset 120.

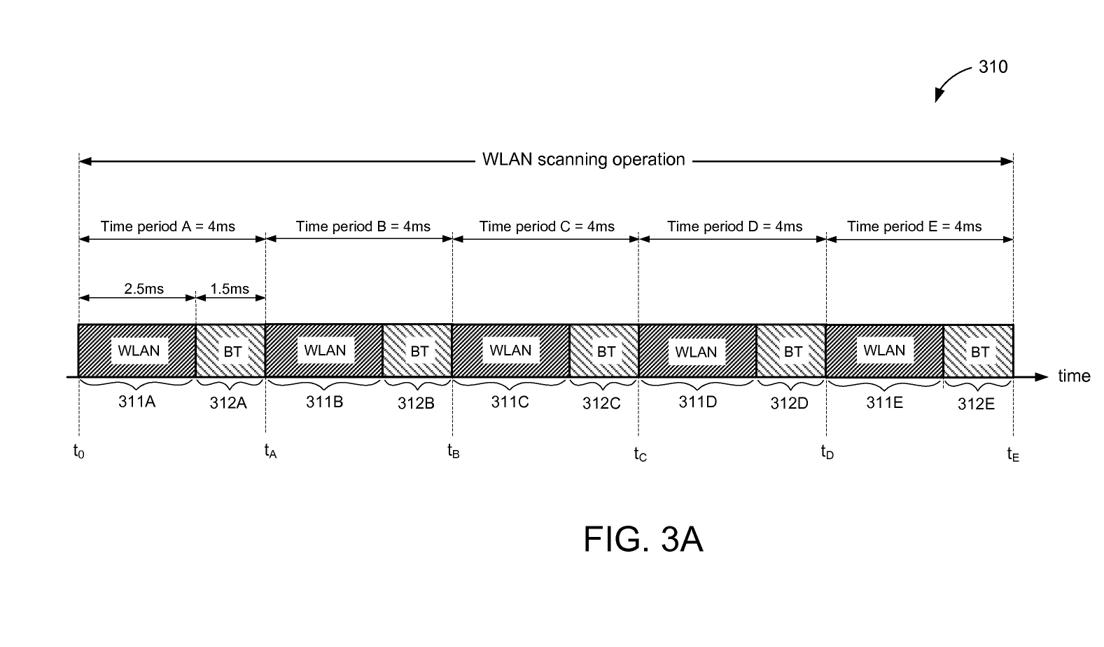

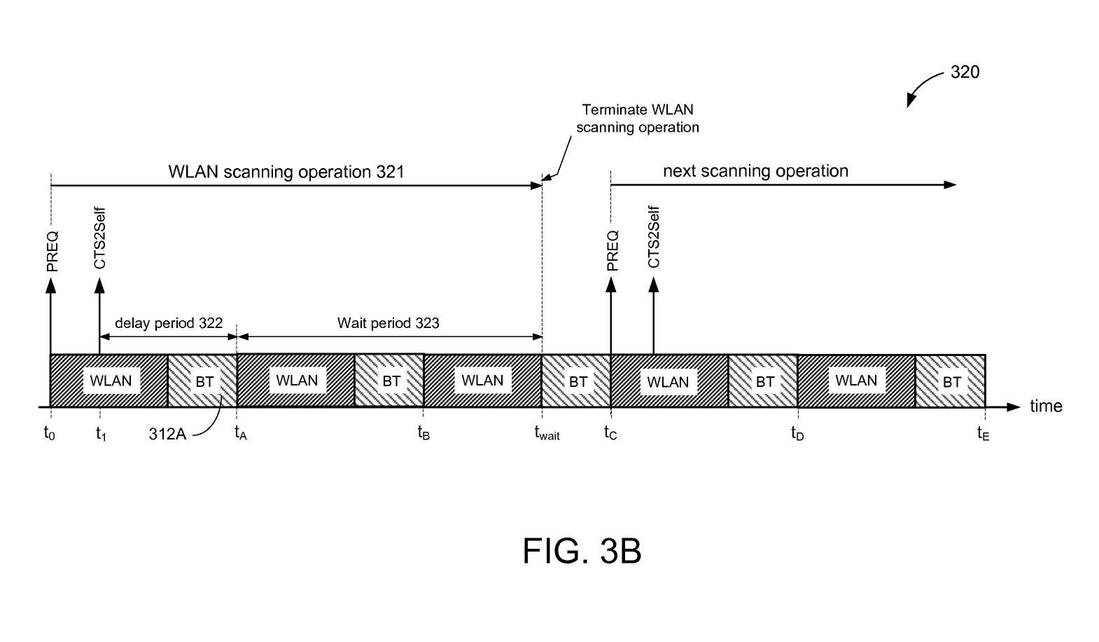

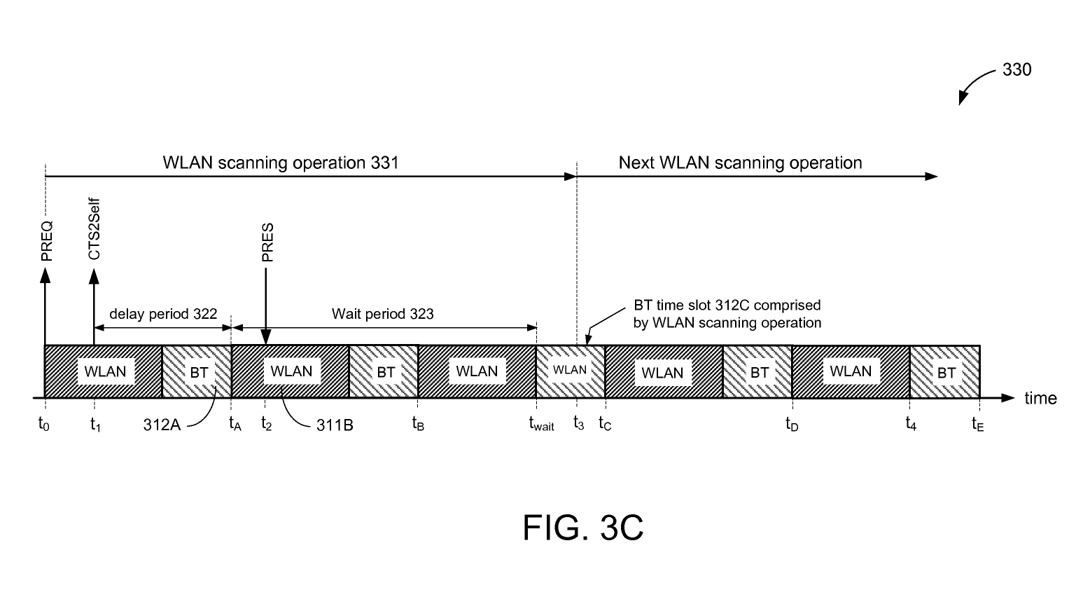

In addition, completion of the WLAN scanning operation may compromise a number of the time slots that a shared antenna is to transmit/receive BT communications. For example, a typical WLAN scanning operation may take between approximately 20 to 40 ms to complete. Thus, for the above-mentioned example implementation in which each 4 ms antenna sharing time period is divided into a 2.5 ms WLAN time slot and a 1.5 ms BT time slot, performing a full WLAN scanning operation may consume between 5-10 consecutive BT time slots. This scenario is illustrated in the example timing diagram 310 of FIG. 3A, which shows allocation of a shared antenna (e.g., antenna 250(1) of STA 200) divided into a number of antenna sharing time periods A-D. Each of the time periods A-D has a duration of 4 ms, and is divided into a WLAN time slot having a duration of 2.5 ms and a BT time slot having a duration of 1.5 ms. For example, the first time period A lasts from time t₀ to time t_{A}, and includes a first WLAN time slot 311A and a first BT time slot 312A; the second time period B lasts from time t_{A} to time t_{B}, and includes a second WLAN time slot 311B and a second BT time slot 312B, and so on.

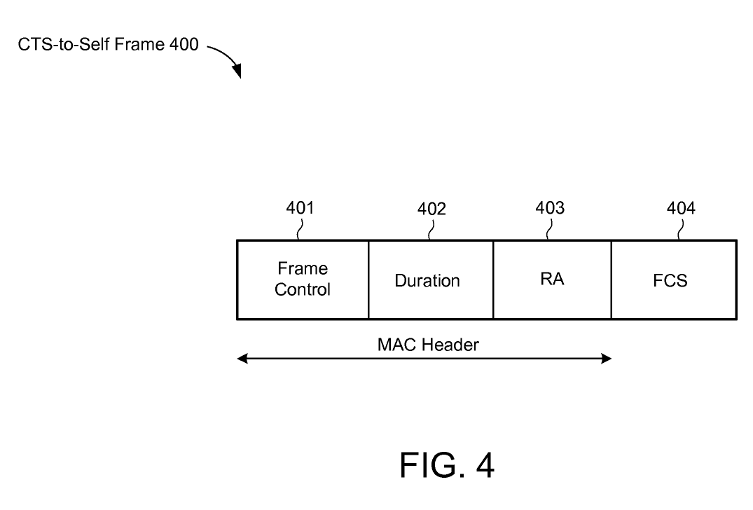

In order to reduce interference with BT transmissions, the STA 200 may instruct the one or more APs in WLAN 111 to delay sending probe responses by a delay period—which for at least some embodiments may have a time duration equal to a remaining time of the current WLAN time slot plus the duration of one BT time slot. Instructing the one or more APs to delay sending probe responses may ensure that the BT time slots allocated to the shared antenna of the STA 200 are not compromised after a probe request is broadcast by the STA 200 to initiate the WLAN scanning operation. For some embodiments, the STA 200 may instruct the APs to delay sending probe responses by broadcasting a particular CTS (Clear to Send) frame called a CTS-to-Self frame. As further described below in reference to FIG. 4, the CTS-to-Self frame may specify the delay period for which the APs are to delay sending probe responses.

For some embodiments, the STA 200 may check or monitor the wireless channel used for the WLAN scanning operation (e.g., using CCA logic 214A) to determine whether the wireless channel is idle or busy during a wait period that begins after expiration of the delay period. At the end of the wait period, if the STA 200 determines that the wireless channel has been idle and no probe responses were received during the wait period, the STA 200 may terminate the WLAN scanning operation. The wait period may be of a duration that is a fraction of the WLAN scan time, for example, so that minimal BT interference is caused by the WLAN scanning operation and/or so that the WLAN scanning operation is terminated (before completion) when there is not a suitable likelihood of finding an AP that offers better performance (e.g., greater goodput, higher RSSI values, and so on) than the current associated AP 110A. As used herein, the term “suitable likelihood” may indicate that there are one or more available APs within wireless range of the STA 200 based on one or more probe responses being received during the wait period. Conversely, if the wireless channel is busy and one or more probe responses are received during the wait period, then the STA 200 may complete the WLAN scanning operation and thereafter associate with the best available AP. In this manner, the selective termination of WLAN scanning operations may ensure that the VoIP call is not dropped even though STA 200 may have moved within the WLAN 111 (e.g., in a direction away from the associated AP 110A).

FIG. 3B illustrates a sequence diagram 320 depicting an example scanning operation in accordance with some embodiments. Referring also to FIGS. 1 and 2, STA 200 is facilitating a VoIP/SCO call using WLAN transceiver 221 and BT transceiver 222 on a shared antenna 250(1) prior to time t₀. At or just after time t₀, STA 200 initiates a WLAN scanning operation 321 (e.g., to identify the best available AP) by broadcasting a probe request (PREQ) to the APs 110A-110F of WLAN 111. At time t₁, STA 200 broadcasts a CTS-to-Self (CTS2Self) frame instructing the APs 110A-110F to delay sending probe responses for a delay period 322 that begins upon receipt of the CTS 2Self frame. For some embodiments, the duration between times t₀ and t₁ may correspond to the transmit time of the PREQ. Instructing the APs 110A-110F to delay sending probe responses until after expiration of the delay period 322 not only reduces interference of BT signals during the delay period 322 but also ensures that the first BT time slot 312A is not compromised by the WLAN transceiver 221 attempting to receive probe responses on the shared antenna 250(1). STA 200 then determines whether any probe responses are received during a wait period 323. The wait period 323 begins upon expiration of the delay period 322, and may last until time t_{wait}. For the example of FIG. 3B, no probe responses are received during the wait period 323 which may indicate that there are no APs within range of STA 200 (or that no nearby APs are able to respond to the PREQ). In response to not receiving any probe responses during the wait period 323, STA 200 terminates the WLAN scanning operation 321 at time t_{wait}. By terminating the WLAN scanning operation 321 at time t_{wait} (rather than allowing the WLAN scanning operation 321 to continue until completion, for example, at time t_{E}), the STA 200 may more quickly perform scanning operations on other channels (e.g., as compared to the example operation depicted in FIG. 3A).

FIG. 3C illustrates a sequence diagram 330 depicting another example scanning operation in accordance with some embodiments. Similar to the operation depicted in FIG. 3B, STA 200 is facilitating a VoIP/SCO call using WLAN transceiver 221 and BT transceiver 222 on a shared antenna 250(1) prior to time t₀. At or just after time t₀, STA 200 initiates a WLAN scanning operation 331 by broadcasting a PREQ to the APs 110A-110F of WLAN 111. At time t₁, STA 200 broadcasts a CTS2Self frame instructing the APs 110A-110F to delay sending probe responses for the delay period 322. STA 200 then determines whether any probe responses are received during the wait period 323. For the example of FIG. 3C, a probe response (PRES) is received during the wait period 323, at time t₂. In response thereto, STA 200 may verify that the received frame is a probe response by checking the MAC header of the PRES. If STA 200 determines that the received frame is not a probe response, then STA 200 may ignore the frame and continue monitoring the wireless channel to determine if additional frames are received during the wait period 323.

Conversely, if STA 200 determines that the received frame is a probe response, as depicted in the example of FIG. 3C, then the STA 200 may check the physical layer convergence protocol (PLCP) portion of the received frame to determine whether the entire probe response may be received during the remainder of the current WLAN time slot 311B. If so, as depicted in the example of FIG. 3C, then STA 200 may complete the WLAN scanning operation 331 and decode the PRES to obtain information about the transmitting AP (e.g., to determine whether the transmitting AP offers better performance than the currently associated AP), and may thereafter initiate a next WLAN scanning operation on another channel. Note that because the example WLAN scanning operation 331 of FIG. 3C lasts until time t₃, the BT time slot 312C may be compromised by Wi-Fi traffic associated with the WLAN scanning operation 331. Otherwise, if the STA 200 cannot receive the entire PRES during the remainder of the current WLAN time slot 311B, then the STA 200 may terminate the WLAN scanning operation 331.

FIG. 4 shows an example CTS-to-Self frame 400 in accordance with example embodiments. The CTS-to-Self frame 400 is shown to include a frame control field 401, a duration field 402, a Receiver Address (RA) field 403, and a Frame Control Sequence (FCS) field 404. The RA field 403 contains the MAC address of the STA 200, for example, to reserve the shared wireless medium for transmissions from STA 200 for a duration indicated in the duration field 402. In accordance with the example embodiments, the STA 200 may store the value of the delay period (e.g., the delay period 322 depicted in FIGS. 3B and 3C) in the duration field 402. Thus, for the example CTS-to-Self frame 400, the duration=the delay period 322 and the receiver address=the transmitter address. As described above, the delay period may be used by the STA 200 to ensure that its BT time slots are not compromised or interrupted by reception of probe responses sent by one or more APs in response to a probe request broadcast by the STA 200. As described above, for at least some embodiments, the delay period may be equal to a remaining time of a current WLAN time slot plus a duration of the next BT time slot. For other embodiments, the delay period may be equal to a remaining time of a current WLAN time slot plus a duration of any suitable number of subsequent BT time slots and WLAN time slots.

FIG. 5 shows an illustrative flow chart depicting an example operation 500 for selectively terminating a WLAN scanning operation in accordance with example embodiments. The example operation 500 is described below with respect to the STA 200 of FIG. 2; for other implementations, the example operation 500 may be performed by any suitable wireless device. Referring also to FIG. 2, the STA 200 may facilitate a voice call with another device using its WLAN transceiver 221 and its BT transceiver 222 (502). Thus, for at least some embodiments, the voice call may be a VoIP/SCO call. For other embodiments, the call may be a cellular call for which audio signals are routed to a BT device (e.g., in an LTE/SCO call). The STA 200 may initiate a WLAN scanning operation by broadcasting a probe request to one or more APs (504). The STA 200 may broadcast the probe request using WLAN transceiver 221 and/or by executing the frame formation and exchange SW module 242. Then, the STA 200 may instruct the one or more APs to delay sending a probe response for a delay period (506). For some embodiments, the STA 200 may calculate the delay period, and broadcast a CTS-to-Self frame containing an indication of the delay period to the one or more APs (506A). The STA 200 may calculate the delay period using co-existence manager 214 and/or by executing the co-existence SW module 244, and may broadcast the CTS-to-Self frame using WLAN controller 211 and WLAN transceiver 221, by executing the frame formation and exchange SW module 242, and/or by executing the dynamic scanning SW module 243.

The STA 200 may selectively terminate the WLAN scanning operation based, at least in part, on a determination that the wireless channel has been idle for more than a wait period after expiration of the delay period (508). For at least some embodiments, when no probe responses are received during the wait period (e.g., the wireless channel is idle), the STA 200 may terminate the WLAN scanning operation (508A). Conversely, when one or more probe responses are received during the wait period (e.g., the wireless channel is busy), the STA 200 may complete the WLAN scanning operation (508B). The STA 200 may determine whether the wireless channel has been idle for more than the wait period after expiration of the delay period using the co-existence manager 214 and/or by executing the dynamic scanning SW module 243.

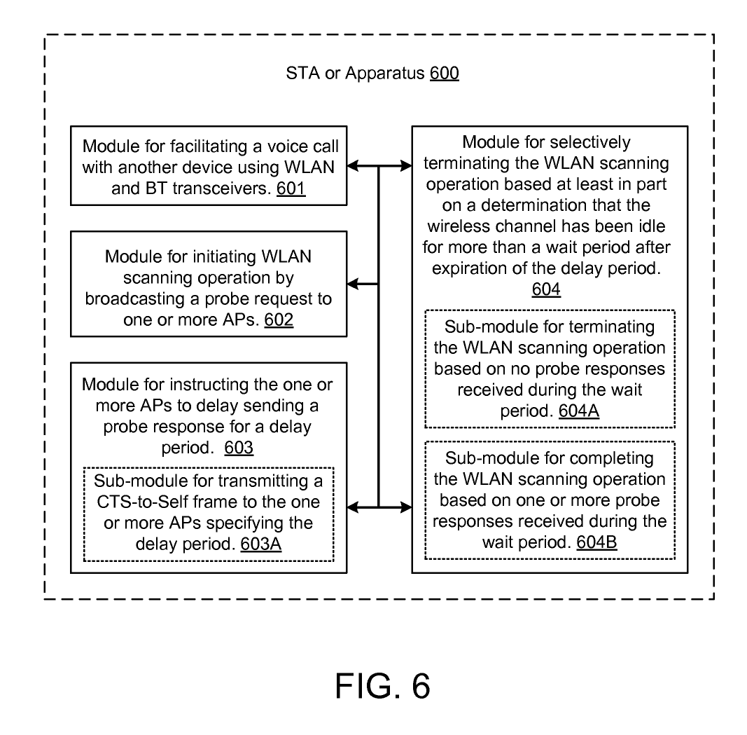

FIG. 6 shows an example STA 600 represented as a series of interrelated functional modules. A module 601 for facilitating a voice call with another device using both Wi-Fi signals and BT signals may correspond at least in some aspects to, for example, a processor as discussed herein (e.g., processor 230) and/or one or more transceivers as discussed herein (e.g., WLAN transceiver 221 and BT transceiver 222).

A module 602 for initiating a WLAN scanning operation by sending a probe request to one or more APs may correspond at least in some aspects to, for example, a processor as discussed herein (e.g., processor 230 executing the frame formation and exchange SW module 242 and/or executing the dynamic scanning SW module 243) and/or may correspond at least in some aspects to, for example, a transceiver as discussed herein (e.g., WLAN transceiver 221 and BT transceiver 222).

A module 603 for instructing the one or more APs to delay sending a probe response for a delay period may correspond at least in some aspects to, for example, a processor as discussed herein (e.g., processor 230 executing the frame formation and exchange SW module 242 and/or executing the dynamic scanning SW module 243). For some implementations, the module 603 may include a sub-module 603A for transmitting a CTS-to-Self frame. Sub-module 603A may correspond at least in some aspects to, for example, a processor as discussed herein (e.g., processor 230 executing the frame formation and exchange SW module 242 and/or executing the dynamic scanning SW module 243).

A module 604 for selectively terminating the WLAN scanning operation may correspond at least in some aspects to, for example, a processor as discussed herein (e.g., processor 230 executing the dynamic scanning SW module 243) and/or to co-existence manager 214. For some implementations, the module 604 may include a sub-module 604A for terminating the WLAN scanning operation and may include a sub-module 604B for completing the WLAN scanning operation. The sub-module 604A may correspond at least in some aspects to, for example, a processor as discussed herein (e.g., processor 230 executing the dynamic scanning SW module 243) and/or to co-existence manager 214. The sub-module 604B may correspond at least in some aspects to, for example, a processor as discussed herein (e.g., processor 230 executing the dynamic scanning SW module 243) and/or to co-existence manager 214.

The functionality of the modules of FIG. 6 may be implemented in various ways consistent with the teachings herein. In some embodiments, the functionality of these modules may be implemented as one or more electrical components. In some designs, the functionality of these blocks may be implemented as a processing system including one or more processor components. In some designs, the functionality of these modules may be implemented using, for example, at least a portion of one or more integrated circuits (e.g., an ASIC). As discussed herein, an integrated circuit may include a processor, software, other related components, or some combination thereof. Thus, the functionality of different modules may be implemented, for example, as different subsets of an integrated circuit, as different subsets of a set of software modules, or a combination thereof. Also, it will be appreciated that a given subset (e.g., of an integrated circuit and/or of a set of software modules) may provide at least a portion of the functionality for more than one module.

In addition, the components and functions represented by FIG. 6, as well as other components and functions described herein, may be implemented using any suitable means. Such means also may be implemented, at least in part, using corresponding structure as taught herein. For example, the components described above in conjunction with the “module for” components of FIG. 6 also may correspond to similarly designated “means for” functionality. Thus, in some aspects one or more of such means may be implemented using one or more of processor components, integrated circuits, or other suitable structure as taught herein.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The methods, sequences or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

In the foregoing specification, embodiments have been described with reference to specific examples thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

More specifically, although the example embodiments are described above with respect to using Wi-Fi signals to facilitate a VoIP call and using Bluetooth signals to route audio signals associated with the VoIP call to a wireless headset, the example embodiments are equally applicable to methods and devices using signals associated with other suitable wireless communication protocols. Thus, for other embodiments, the STA 200 may facilitate the VoIP call using any suitable wireless communication protocol (e.g., using LTE, Bluetooth, or WiGig communication protocols), and may route audio signals associated with the VoIP call to a wireless headset using any suitable wireless communication protocol (e.g., using LTE, Wi-Fi, or WiGig communication protocols).

1. A method of operating a wireless device, the method comprising:
facilitating a voice call using a wireless local area network (WLAN) transceiver and a Bluetooth (BT) transceiver;
initiating a WLAN scanning operation during the voice call by broadcasting a probe request, over a wireless channel, to one or more access points (APs);
instructing the one or more APs to delay sending a probe response for a delay period; and
selectively terminating the WLAN scanning operation based at least in part on a determination that the wireless channel has been idle for more than a wait period after expiration of the delay period.

2. The method of claim 1, wherein the instructing comprises transmitting, to the one or more APs, a CTS-to-Self frame specifying the delay period.

3. The method of claim 1, wherein the probe request is broadcasted to the one or more APs at a beginning of a time slot allocated to the WLAN transceiver.

4. The method of claim 3, wherein the instructing comprises transmitting, to the one or more APs, a CTS-to-Self frame during the time slot allocated to the WLAN transceiver.

5. The method of claim 3, wherein the delay period is equal to a remaining time in the time slot allocated to the WLAN transceiver plus one time slot allocated to the BT transceiver.

6. The method of claim 1, wherein the determination that the wireless channel has been idle for more than the wait period is based, at least in part, on a Clear Channel Assessment (CCA).

7. The method of claim 1, wherein the wait period comprises a number of WLAN time slots.

8. The method of claim 1, wherein the selectively terminating comprises:
terminating the WLAN scanning operation based on a determination that the wireless device has not received any probe responses during the wait period; and
completing the WLAN scanning operation based on a determination that the wireless device has received one or more probe responses during the wait period.

9. A mobile station (STA) to scan for nearby access points (APs) during a voice call, the STA comprising:
a wireless local area network (WLAN) transceiver to exchange wireless signals with at least one AP during the voice call;
a Bluetooth (BT) transceiver to exchange wireless signals with a BT device during the voice call;
one or more processors; and
a memory storing instructions that, when executed by the one or more processors, cause the STA to:
initiate a WLAN scanning operation during the voice call by broadcasting a probe request, over a wireless channel, to a number of APs;
instruct the number of APs to delay sending a probe response for a delay period; and
selectively terminate the WLAN scanning operation based at least in part on a determination that the wireless channel has been idle for more than a wait period after expiration of the delay period.

10. The mobile station of claim 9, wherein execution of the instructions to instruct the number of APs to delay sending the probe response causes the STA to transmit, to the number of APs, a CTS-to-Self frame specifying the delay period.

11. The mobile station of claim 9, wherein execution of the instructions to initiate the WLAN scanning operation causes the STA to broadcast the probe request to the number of APs at a beginning of a time slot allocated to the WLAN transceiver.

12. The mobile station of claim 11, wherein execution of the instructions to instruct the number of APs causes the STA to transmit, to the number of APs, a CTS-to-Self frame during the time slot allocated to the WLAN transceiver.

13. The mobile station of claim 11, wherein the delay period is equal to a remaining time in the time slot allocated to the WLAN transceiver plus one time slot allocated to the BT transceiver.

14. The mobile station of claim 9, wherein the determination that the wireless channel has been idle for more than the wait period is based, at least in part, on a Clear Channel Assessment (CCA).

15. The mobile station of claim 9, wherein the wait period comprises a number of WLAN time slots.

16. The mobile station of claim 9, wherein execution of the instructions to selectively terminate the WLAN scanning operation causes the STA to:
terminate the WLAN scanning operation based on a determination that the STA has not received any probe responses during the wait period; and
complete the WLAN scanning operation based on a determination that the STA has received one or more probe responses during the wait period.

17. A non-transitory computer-readable medium storing instructions that, when executed by one or more processors of a mobile station (STA) while the STA is facilitating a voice call using a wireless local area network (WLAN) transceiver and a Bluetooth (BT) transceiver, causes the STA to scan for nearby access points (APs) by performing operations comprising:
initiating a WLAN scanning operation during the voice call by broadcasting a probe request, over a wireless channel, to one or more APs;
instructing the one or more APs to delay sending a probe response for a delay period; and
selectively terminating the WLAN scanning operation based at least in part on a determination that the wireless channel has been idle for more than a wait period after expiration of the delay period.

18. The non-transitory computer-readable medium of claim 17, wherein execution of the instructions to instruct the one or more APs to delay sending the probe response causes the STA to transmit, to the one or more APs, a CTS-to-Self frame specifying the delay period.

19. The non-transitory computer-readable medium of claim 17, wherein execution of the instructions to initiate the WLAN scanning operation causes the STA to broadcast the probe request to the one or more APs at a beginning of a time slot allocated to the WLAN transceiver.

20. The non-transitory computer-readable medium of claim 19, wherein execution of the instructions to instruct the one or more APs causes the STA to transmit a CTS-to-Self frame to the one or more APs during the time slot allocated to the WLAN transceiver.

21. The non-transitory computer-readable medium of claim 20, wherein the delay period is equal to a remaining time in the time slot allocated to the WLAN transceiver plus one time slot allocated to the BT transceiver.

22. The non-transitory computer-readable medium of claim 17, wherein the determination that the wireless channel has been idle for more than the wait period is based, at least in part, on a Clear Channel Assessment (CCA).

23. The non-transitory computer-readable medium of claim 17, wherein the wait period comprises a number of WLAN time slots.

24. The non-transitory computer-readable medium of claim 17, wherein execution of the instructions to selectively terminate the WLAN scanning operation causes the STA to perform operations further comprising:
terminating the WLAN scanning operation based on a determination that the STA has not received any probe responses during the wait period; and
completing the WLAN scanning operation based on a determination that the STA has received one or more probe responses during the wait period.

25. A mobile station (STA) to scan for nearby access points (APs), the STA comprising:
means for facilitating a voice call using a wireless local area network (WLAN) transceiver and a Bluetooth (BT) transceiver;
means for initiating a WLAN scanning operation during the voice call by broadcasting a probe request, over a wireless channel, to one or more access points (APs);
means for instructing the one or more APs to delay sending a probe response for a delay period; and
means for selectively terminating the WLAN scanning operation based at least in part on a determination that the wireless channel has been idle for more than a wait period after expiration of the delay period.

26. The mobile station of claim 25, wherein the means for instructing is to transmit, to the one or more APs, a CTS-to-Self frame specifying the delay period.

27. The mobile station of claim 25, wherein the means for initiating the WLAN scanning operation is to broadcast the probe request to the one or more APs at a beginning of a time slot allocated to the WLAN transceiver.

28. The mobile station of claim 27, wherein the means for instructing is to transmit a CTS-to-Self frame to the one or more APs during the time slot allocated to the WLAN transceiver.

29. The mobile station of claim 28, wherein the delay period is equal to a remaining time in the time slot allocated to the WLAN transceiver plus one time slot allocated to the BT transceiver.

30. The mobile station of claim 25, wherein the determination that the wireless channel has been idle for more than the wait period is based, at least in part, on a Clear Channel Assessment (CCA).
